(19) United States
(12) Patent Application Publication
(10) Pub. No.: US 2014/0019462 A1
(43) Pub. Date: Jan. 16, 2014

(54) CONTEXTUAL QUERY ADJUSTMENTS USING NATURAL ACTION INPUT

(71) Applicants: Larry Paul Heck, Los Altos, CA (US); Madhusudan Chinthakunta, Saratoga, CA (US); Rukmini Iyer, Los Altos, CA (US)

(72) Inventors: Larry Paul Heck, Los Altos, CA (US); Madhusudan Chinthakunta, Saratoga, CA (US); Rukmini Iyer, Los Altos, CA (US)

(73) Assignee: Microsoft Corporation, Redmond, WA (US)

(21) Appl. No.: 13/549,503

(22) Filed: Jul. 15, 2012

(51) Int. Cl. G06F 17/30

(52) U.S. Cl. 707/754; 707/759; 707/E17.059; 707/E17.061

(57) ABSTRACT

Within the field of computing, many scenarios involve queries formulated by users resulting in query results presented by a device. The user may request to adjust the query, but many devices can only process requests specified in a well-structured manner, such as a set of recognized keywords, specific verbal commands, or a specific manual gesture. The user thus communicates the adjustment request in the constraints of the device, even if the query is specified in a natural language. Presented herein are techniques for enabling users to specify query adjustments with natural action input (e.g., natural-language speech, vocal inflection, and natural manual gestures). The device may be configured to evaluate the natural action input, identify the user's intended query adjustments, generate an adjusted query, and present an adjusted query result, thus enabling the user to interact with the device in a similar manner as communicating with an individual.

### BACKGROUND

Within the field of computing, many scenarios involve a query submitted by a user, such as a search of a file system for files a desired set of files, a select query of a database specifying query conditions, a filtering or ordering of objects in an object set, or a search query submitted to a web search engine to identify a set of matching web pages. In these and other scenarios, the query may be submitted by a user in various ways, such as a textual entry of keywords or other logical criteria; a textual or spoken natural-language input that may be parsed into a query; or an automated contextual presentation, such as a global positioning system (GPS) receiver that presents locations of interest near a currently detected location.

In these and other scenarios, the device may use a query to generate a query result (e.g., by directly executing the query and identifying matching results, or by submitting the query to a search engine and receiving the query results). The device may also add contextual clues to the query, such as by ordering a search for restaurants according to the proximity of each restaurant to a currently detected location of the user. If the user is not satisfied with the query result, the device may permit the user to enter a new query and may present a different query result. Alternatively, the device may allow the user to adjust the query through conventional forms of user input, such as using a keyboard to manually edit the text of a query for resubmission; to select a portion of a search result using a pointing device, such as a touch-sensitive display, a mouse, or a trackball; or entering keywords corresponding to various actions such as showing a next subset of search results. These and other techniques for mapping actions to conventional data entry techniques of a device in order to adjust the contents and/or order of a query.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While the updating of a query using conventional input or contextual clues may be helpful, these techniques may not properly apply many types of query adjustments that a user may specify with a natural action input. For example, the user may present language input that does not conform to the query-altering keywords recognized by the device such as “next” and “restart,” but that represents natural-language input that is cognizable by other individuals, such as “show me more results” and “go back to the first page.” Alternatively or additionally, the user may use natural actions corresponding to nonverbal communication that does not physically contact any input component of the device, such as a vocal inflection, a manual gesture performed in the air (e.g., pointing at a search result presented on the display but not touching the display), and ocular gaze focusing on a portion of the search results. The recognition, evaluation, and application for adjusting the query may be performed by the device, the server of the search result, and/or a different server, such as an “action broker” that translates natural action inputs to invokable actions that adjust the query result. These and other variations in the adjustment of a query result through the detection, evaluation, and application of natural action input may be achieved according to the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a submission and adjustment of queries and query results based on keywords.

FIG. 2 is an illustration of an exemplary scenario featuring a submission and adjustment of queries and query results based on natural action input according to the techniques presented herein.

FIG. 3 is a flow diagram illustrating an exemplary method of presenting query results to a device using a server in accordance with the techniques presented herein.

FIG. 4 is an illustration of an exemplary scenario featuring a server configured to present query results to a device according to the techniques presented herein.

FIG. 5 is a flow diagram illustrating an exemplary method of facilitating query results presented by devices and comprising at least one entity in accordance with the techniques presented herein.

FIG. 6 is an illustration of an exemplary scenario featuring a server configured to facilitate query results presented by devices and comprising at least one entity according to the techniques presented herein.

FIG. 7 is a flow diagram illustrating an exemplary method of presenting query results in response to a query received from a user in accordance with the techniques presented herein.

FIG. 8 is an illustration of an exemplary computer-readable storage device comprising instructions that, when executed on a processor of a device, cause the device to present query results of a query in accordance with the techniques presented herein.

FIG. 9 is an illustration of an exemplary scenario featuring a presentation of query results including entities associated with entity references and entity actions in accordance with the techniques presented herein.

FIG. 10 is an illustration of an exemplary scenario featuring a focusing of a query result on an entity and a presentation of entity actions associated with the entity in accordance with the techniques presented herein.

FIG. 11 is an illustration of an exemplary scenario featuring a disambiguation of a natural user action in the context of the presentation of the query results in accordance with the techniques presented herein.

FIG. 12 is an illustration of an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve a submission of a query by a user to a device that is executed to generate a query result for presentation to the user. As a first example, a user may submit a query including a description of files of interest (e.g., a partial filename match, a file type, or a creation date range), and the device may examine a local file system and present a list of files matching the description. As a second example, a user may submit a filtering database query, such as a SELECT query in the Structured Query Language (SQL), and the device may search a database for records identified by the query. As a third example, a user may provide criteria for a set of objects, such as email messages in an email database, and the device may identify the messages matching the criteria. As a fourth example, a user may submit a search query to a web search engine, which may identify and present a set of search results comprising descriptions and links of web pages matching the search query. The query result may be statically presented, or the device may enable the user to interact with the query result, e.g., by selecting an entity in the query result (e.g., a web page included in a web search result) and presenting to the user the contents of the selected web page.

In these and other scenarios, the user may present the query in many ways. As a first example, the user may utilize a text input device, such as a keyboard, or a pointing device, such as a mouse, stylus, or touch-sensitive display, to specify the details of the query, such as a set of keywords to be included in the titles or bodies of web pages presented in a web search query result. In some such scenarios, the user may speak or hand-write the query to the device, which may utilize a speech or handwriting analyzer to identify the content of the spoken utterance. Additionally, the query may be specified according to logical criteria, such as keywords, numbers representing date ranges, and Boolean operators, or may be submitted as a “natural-language” query, wherein the user expresses a sentence describing the sought data as if the user were speaking naturally to another individual. In these scenarios, the device may parse the query using a natural-language lexical analyzer in order to identify the criteria specified by the user's speech. Additionally, in these and other scenarios, a user who is not fully satisfied with the query result may endeavor to adjust the query in order to generate and present a query result that is closer to the user's intent in formulating the query. For example, a user searching the web for “Washington” may encounter many pages about both the United States state of Washington and the individual named George Washington, and may only be interested in the latter. The user may therefore input a new query specifying both “George Washington” to adjust the query results in favor of the desired topic.

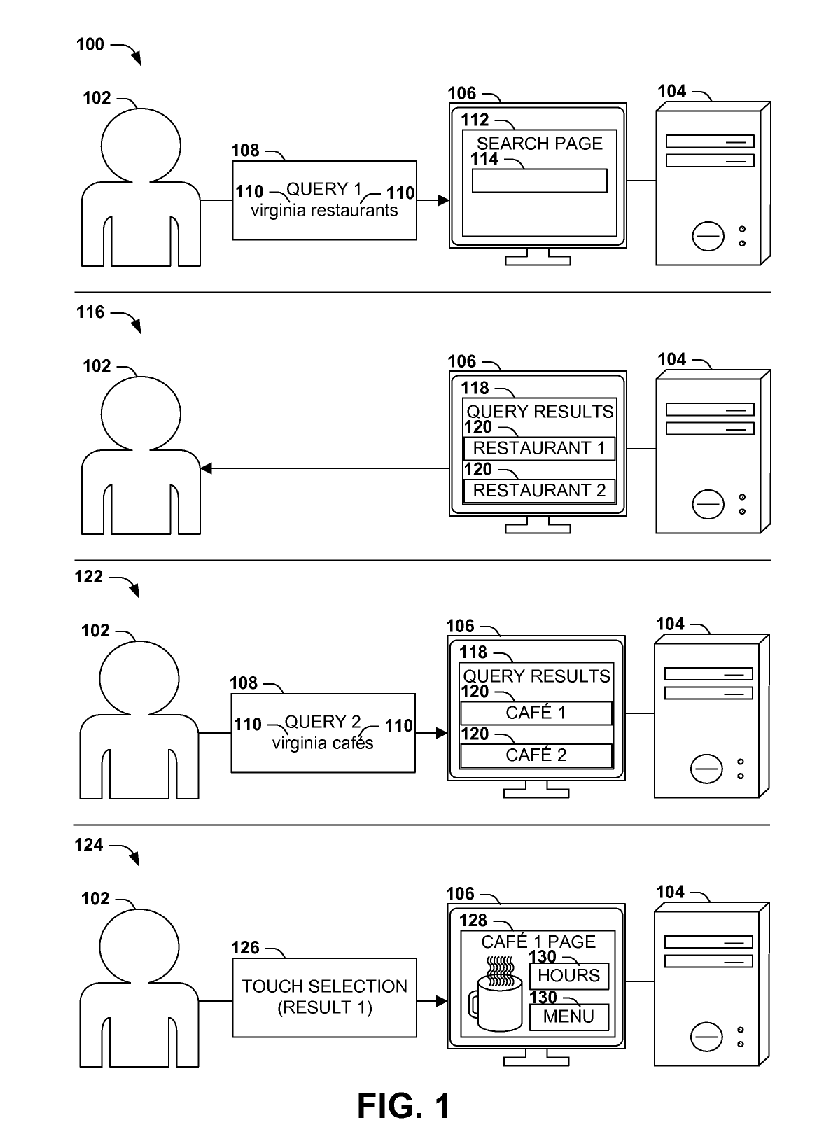

FIG. 1 presents an illustration of an exemplary scenario featuring a user 102 of a device 104 submitting a first query 108. At a first time point 100, the device 104 may present to the user 102 a search page 112, such as a home page for a search engine, and including a query text-input control 114 that is configured to receive the first query 108 from the user 102. The user 102 may therefore submit a set of keywords 110 that identify the pages of interest to the user 102. Upon deciding to act upon the submission, the device 104 may present the first query 108 in the query input control 114 and, upon completing or receiving the query results 118 at a second time point 116, may present the query results 118 to the user 102 (e.g., as a set of entities 120, such as restaurants identified in a restaurant directory, matching the keywords 110 of the query 108). If the user 102 is not satisfied with the query results 118, the user 102 may, at a third time point 112, formulate a second query 108 with different keywords 110, such as by manually editing the contents of the first query 108 to include a narrower keyword 110, and may submit the second query 108 to view a second query result 118 with different entities 120. At a fourth time point 124, the user 102 may perform a touch selection 126 on the display 106 of the device 104 to select an entity 120 (e.g., touching the entry for the first entity 120), and the device 104 may respond by presenting more detail about the selected entry, such as the web page 128 for the entity 120. Moreover, the web page 128 may include a set of actions 130 relating to the entity 120, such as viewing the operating hours of the café and viewing a menu for the café. In this manner, the device 104 may enable the user 102 to input and adjust a keyword-based query 108 and to interact with the query results 106.

The techniques presented in the exemplary scenario of FIG. 1 may vary in some ways. For example, the user 102 may enter the query 108 as a set of keywords 110, as a filter comprising a set of criteria and logical connectors, as a data query in a language such as the Structured Query Language (SQL), or as a natural-language query such as a request presented in a natural human language. Additionally, the user 102 may adjust the query 108 by manually altering the input provided by the first query, or by formulating a second query 108 that is different from the first query 108.

However, some disadvantages may be identified in the techniques presented in the exemplary scenario of FIG. 1 and variations thereof. As a first example, if the user 102 is not aware of the input components of the device 104 (e.g., if the user 102 is not adept with a keyboard or mouse), specifying the query 108 using such input components may be difficult and inefficient. As a second example, if the user 102 is not familiar with the format of queries 108 that the device 104 is configured to process (e.g., the Structured Query Language, or the manner of specifying criteria and logical operators), the user 102 may be unable to present a properly formatted query 108 that the device 104 may satisfactorily process. As a third example, if the device 104 utilizes a set of keywords and the user 102 does not use such keywords in a correct manner, the query 108 may not return the desired query result 118. For example, devices 104 providing voice-activated applications that process specific uttered keywords such as “select” and “next” may not be suitable for a user 102 who does not now or properly speak the identified keywords. As a fourth example, in order to adjust a query 108, the user 102 either edits the contents of the preceding query 108 (e.g., manually adding, removing, or changing keywords 110) or initiates a new query 108, rather than simply asking the device 104 to adjust the query 108 in a particular way. These and other disadvantages may result from the use of query techniques such as presented in the exemplary scenario of FIG. 1.

### B. Presented Techniques

Presented herein are techniques for enabling users 102 to initiate and adjust queries 108 with greater effective use of intuitive human communication. In particular, it may be appreciated that many of the disadvantages presented in the exemplary scenario of FIG. 1 arise from coercing the user 102 to provide input according to the logical constraints and processes of the device 104 (e.g., instructing a user 102 to learn the Structured Query Language or logical operator set used by the device 104), rather than enabling the user 102 to communicate naturally with the device 104 and the device 104 to interpret such natural user input. While devices 104 are capable of processing natural-language input such as a spoken query, the use of such natural-language input is often constrained to receiving plain text (such as a dictated document), rather than using natural language input to interact with the capabilities of the device 104. For example, an application configured to receive dictation may receive natural-language input for the plain text of a document, and may specify a set of spoken keywords for altering the contents of the text, but may fail to utilize the natural-language input also for receiving commands that alter the contents of the text, such as “This next sentence is in bold.” Similarly, a drawing application may enable a user to draw freehand through touch input on a touch-sensitive device, and may specify a set of touch gestures that specify various drawing commands such as zooming in or out and selecting a different drawing tool, but may fail to interpret freehand drawing as also including the drawing commands provided as natural user actions. That is, the user 102 communicates with the dictation application and the drawing application by learning the specific verbal keywords and touch gestures that invoke respective commands, as well as the details of the input devices such as the keyboard and the touchpad, rather than allowing the user 102 to interact naturally with the device 104 and configuring the device 104 to interpret such natural action input as both specifying content and commands.

The techniques presented herein enable users 102 to interact with a device 104 using various forms of natural user input (e.g., voice- or text-input natural language; vocal inflection; manual gestures performed without touching any component of the device 104; and visual focus on a particular element of a display 106), where such natural user input specifies both content and commands to the device 104. More specifically, the techniques presented herein enable the user 102 to adjust a query 108 by providing natural user actions, and configuring the device 104 to interpret such natural user actions in order to adjust the query 108 and present an adjusted query result 118. Significantly, the user 102 may not have to understand anything about the input components of the device 104 or the commands applicable by the device 104, but may speak, gesture, and otherwise communicate with the device 104 in the same manner as with another individual, and the device 104 may be configured to interpret the intent of the user 102 from such natural action input and adjust the query 108 accordingly. Moreover, such natural action input may utilize a combination of modalities, such as verbal utterances, vocal inflection, manual gestures such as pointing, and ocular focus, in order to resolve ambiguities in input and respond to the full range of natural communication of the user 102.

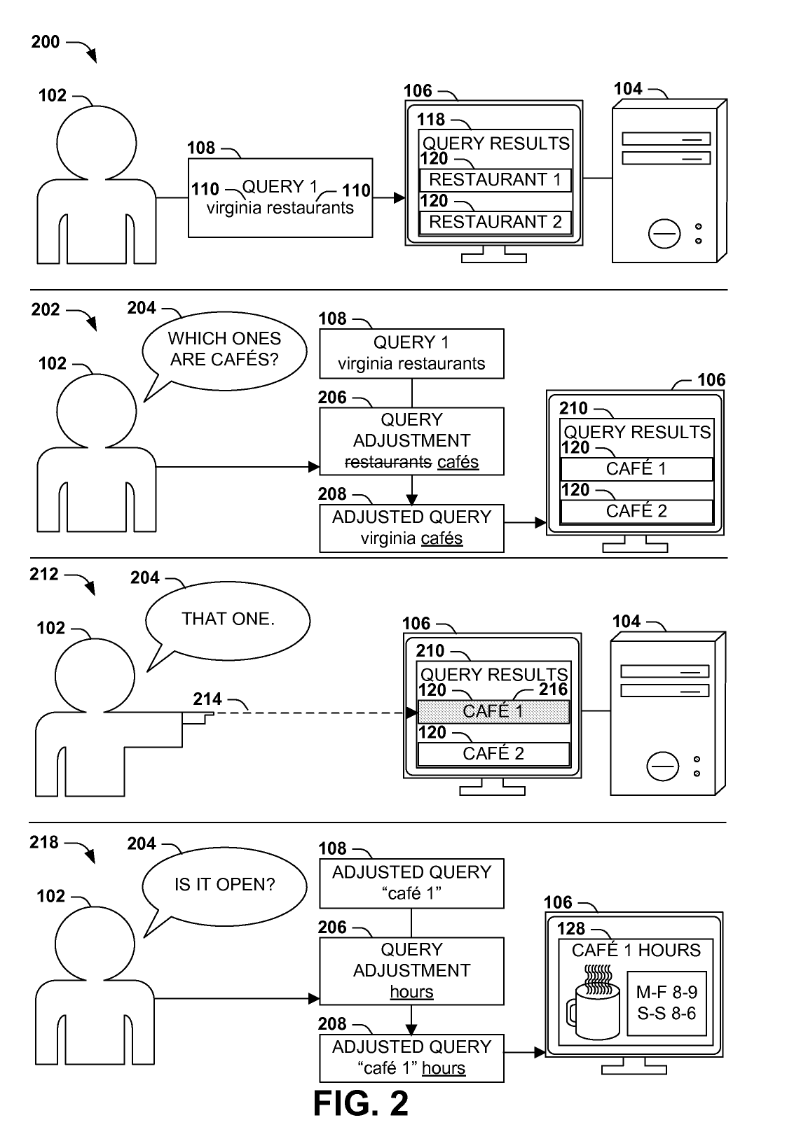

FIG. 2 presents an illustration of an exemplary scenario featuring the adjustment of a query 108 according to the natural user actions of a user 102. In this exemplary scenario, at a first time point 200, the user 102 specifies a first query 108 (e.g., as a set of keywords 110 such as “Virginia” and “restaurants,” or as a natural-language query typed on a keyboard or spoken to the device 104), and the device 104 may present upon the display 106 a query result 118 including a set of entities 120, such as a query 108 requesting a list of restaurants in a particular area and a matching set of restaurants 120. However, at a second time point 202, the user 102 may present natural user input 204 as a request for the device 106 to alter the query, such as by limiting the results to a particular type of restaurant, such as a café. In contrast with the exemplary scenario of FIG. 1, the adjustment request of the user 102 is neither constrained to a limited set of commands recognized by the device 104 (e.g., “INSERT, KEYWORD, CAFÉ), nor the presentation of a reformulated query 108 in the natural language or with a new set of keywords (e.g., “NEW QUERY: Virginia cafés”), but a natural-language request to alter the query 108, such as the user 102 may ask another individual. At this second time point 202, the device 104 may examine the natural action input 204 to identify a query adjustment 206, such as a request to replace the “restaurants” keyword in the first query 108 with a more specific keyword for the type of restaurant 206. Accordingly, the device 104 may generate an adjusted query 208, execute the adjusted query 208, and present an adjusted query result 210, such as the entities 120 comprising restaurants that match the more specific criterion indicated in the natural user input 204.

As further illustrated in FIG. 2, at a third time point 212, the user 102 may concurrently present two forms of natural action input by speaking the natural-language phrase “That one” while manually pointing 214 at an entity 120 on the display 106. The device 104 may interpret these forms of natural user input 204 as together indicating a focusing on the entity 120 displayed at the location on the display 106 where the user 102 is manually pointing 214, such as the query result for the first café. The device 104 may respond to this inference by adjusting the query 108 again to focus on the indicated entity 120 (e.g., limiting the query to the name of the first café); as an action to be performed with the entity 120, such as activating the hyperlink of the search result for the entity 120; or simply by reflecting the focus of the user 102 on the entity 120, e.g., by highlighting the entity 120 as an indication of the user's selection. At a fourth time point 218, the user 102 may issue additional natural action input 204 that further adjusts the query 108. For example, if the user 102 asks a question such as “Is it open?”, the device 106 may evaluate this natural action input 204 as specifying a query adjustment 206 adding the keyword “hours,” an execution of the adjusted query 208 to generate and present an adjusted query result 210 indicating the hours of operation of the café.

The techniques presented in the exemplary scenario of FIG. 2 present several advantages, particularly with respect to techniques presented in the exemplary scenario of FIG. 1. As a first example, the user 102 does not have to understand the operation of the input components of the device 106. As a second example, the user 102 does not have to learn and adapt to the mechanisms for invoking the functionality of the device 106, such as verbal keywords or touch gestures corresponding to specific commands of the device 106, or the nature of a query language or logical operators. Moreover, even if the user 102 may be aware of the commands recognized by the device 106, the user 102 does not have to switch between natural language input presented to specify content (e.g., speech to be construed as the text of a document or touch input to be construed as drawing) and constrained input invoking the functionality of the device 106 (e.g., spoken keywords to invoke formatting options of the document or specific manual gestures to invoke drawing commands). Rather, the user 102 simply communicates with the device 106 as if communicating with another individual, both to specify content and to issue commands to the device 106, and the device 106 is configured to interpret the intent of the user 102. In this manner, the device 106 enables the user 102 to interact more naturally in the submission and adjustment of a query 108 in accordance with the techniques presented herein.

### C. Embodiments

The techniques presented herein may be implemented according to various embodiments. In particular, and as presented in the following discussion, the architecture of the elements of such embodiments may vary; e.g., the natural action input may be interpreted and translated into a query adjustment 206 of a query 108 by the same device 106 receiving the natural user input 204, by a server providing the query results 118 for the query 108, and/or by a different server that facilitates both the device operated by the user 102 and a server providing query results 118.

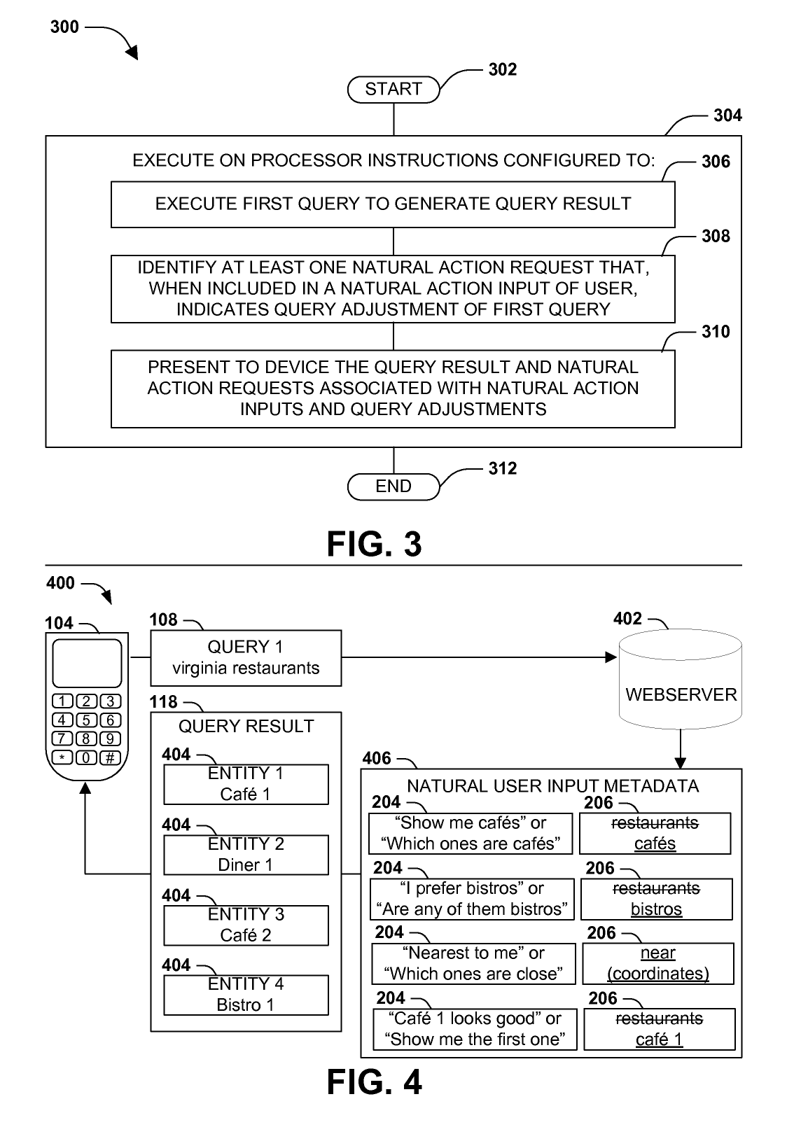

FIGS. 3 and 4 together present a first embodiment of these techniques. FIG. 3 presents an illustration of an exemplary method 300 of configuring a server having a processor to present query results 106 to a user 102 of a device 104. The exemplary method 300 may be implemented, e.g., as a set of instructions stored in a memory component of the server (e.g., a volatile memory circuit, a platter of a hard disk drive, a solid-state storage device, or a magnetic or optical disc) that, when executed on the processor of the server, cause the server to utilize the techniques presented herein. The exemplary method 300 begins at 302 and involves executing 304 the instructions on the processor of the server. In particular, the instructions are configured to, upon receiving a first query 108 from the device 104 provided by a user 102, execute 306 the first query 108 to generate a query result 108. The instructions are also configured to identify 308 at least one natural action request that, when included in a natural action input 204 of the user 102, indicates a query adjustment 206 of the first query 108 (e.g., different phrases that the user 102 might use to various natural-language requests to adjust the query 108, and the query adjustments 206 that may applied to the query 108 as a result). The instructions are also configured to present 310 to the device 106 the query result 118 and the natural action requests associated with the natural action inputs 204 and the corresponding query adjustments 206. Having provided the query results 118 and the types of query adjustments 206 that may be applied to fulfill various types of natural action input 204 received from the user 102, the exemplary method 300 causes the server to present the query results 118 to the device 104 in accordance with the techniques presented herein, and so ends at 312.

FIG. 4 presents an illustration of an exemplary scenario 400 utilizing this architecture. In this exemplary scenario 400, a device 104 presents a query 108 to a server 402 (such as a webserver), which may respond by providing a query result 118 comprising a set of entities 404 identified by the query 108. In addition, the server 402 may provide a set of natural action input metadata 406, such as a set of natural action inputs 204 (e.g., natural-language phrases) that may correspond to respective query adjustments 206 (e.g., keywords to add to, change, or remove from the first query 108). By delivering the query 108 and the natural action input metadata 406 to the device 104, the server 402 facilitates the interaction of the device 104 and the user 102 to adjust the query 108 through natural action input 204 in accordance with the techniques presented herein.

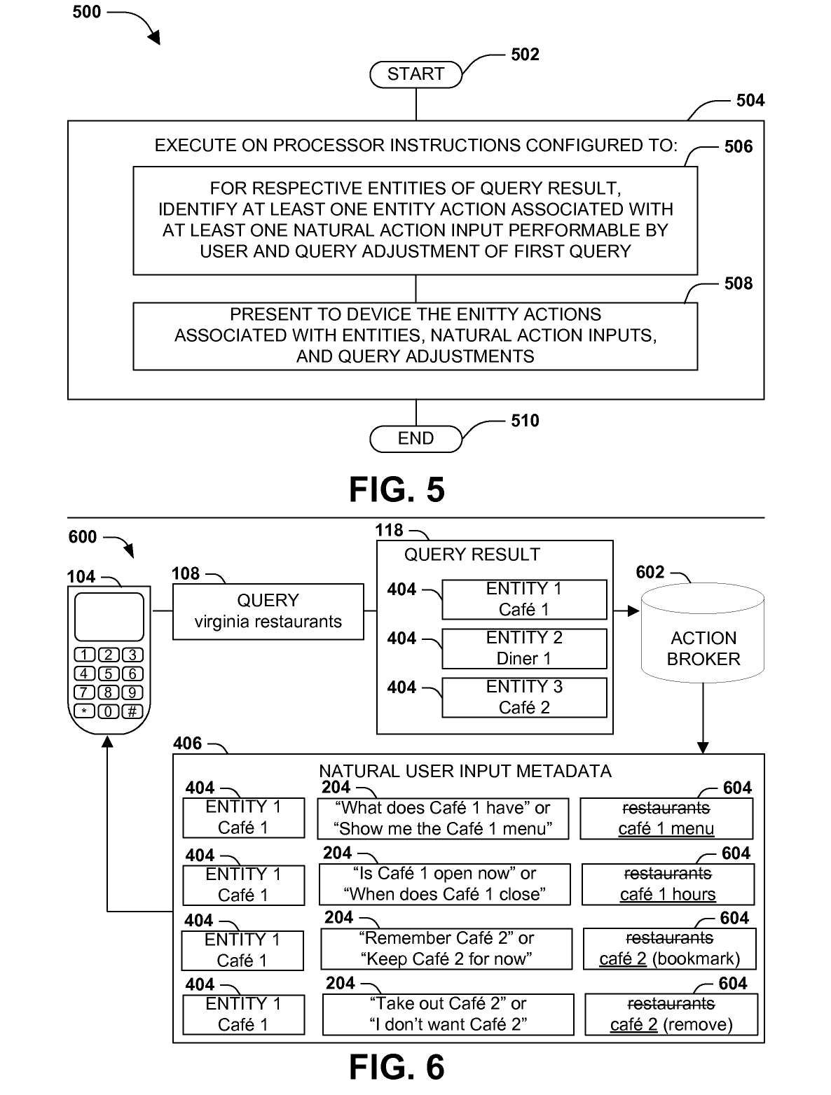

FIGS. 5 and 6 together present a second embodiment of these techniques. FIG. 5 presents an illustration of an exemplary method 500 of configuring a server having a processor to facilitate the presentation of query results by a device 104 to a user 102. In contrast with the exemplary method 300 of FIG. 3, the exemplary method 500 of FIG. 5 may be invoked to facilitate the evaluation of natural action input 204 for query results 118 presented from a different source. The exemplary method 500 may be implemented, e.g., as a set of instructions stored in a memory component of the server (e.g., a volatile memory circuit, a platter of a hard disk drive, a solid-state storage device, or a magnetic or optical disc) that, when executed on the processor of the server, cause the server to utilize the techniques presented herein. The exemplary method 500 begins at 502 and involves executing 504 the instructions on the processor of the server. In particular, the instructions are configured to, upon receiving a first query 108 and a query result 118 from the device 104, identify 506, for respective entities 120 of the query result 118, at least one entity action that is associated with at least one natural action input 204 performable by the user 102 and a corresponding query adjustment 206 of the first query 108. For example, for respective search results in a search results page, the server may identify actions generally associated with each search result (e.g., following the hyperlink specified in the search result, or bookmarking the search result) and/or specifically related to the search result (e.g., for a search result representing a web page of a restaurant, adding the terms “hours,” “location,” or “menu” to limit the web search query to those types of information about the restaurant). The instructions are also configured to present 508 to the device 104 the entity actions associated with the entities 102, the natural action inputs 204, and the corresponding query adjustments 206. Having facilitated the presentation of the query result 118 by identifying the types of query adjustments 206 that may be applied to fulfill various types of natural action input 204 received from the user 102, the exemplary method 500 causes the server to facilitate the device 104 in presenting the query result 118 to the user 102, and so ends at 510.

FIG. 6 presents an illustration of an exemplary scenario 600 featuring a server configured as an action broker 602 that identifies, for a query result 118 received by the device 104 from another source, the actions associated with the entities 404 of the query result 118. When the device 104 sends a query 108 and a query result 118 to the action broker 602, the action broker 602 may examine the query result 118 to identify actions available for respective entities 404. For example, the action broker 602 may send to the device 104 a set of natural action input metadata 406 identifying, for respective entities 404, the natural action inputs 204 associated with various actions 604, and the query adjustments 206 that may be applied to the query 108 to invoke such actions. The device 104 may utilize this metadata to assist in the processing of natural action input 204 received from the user 102 in response to the presentation of the query result 118, even if the source of the query result 118 and the device 104 did not participate in the identification of the natural user inputs 204 corresponding to such query adjustments 206.

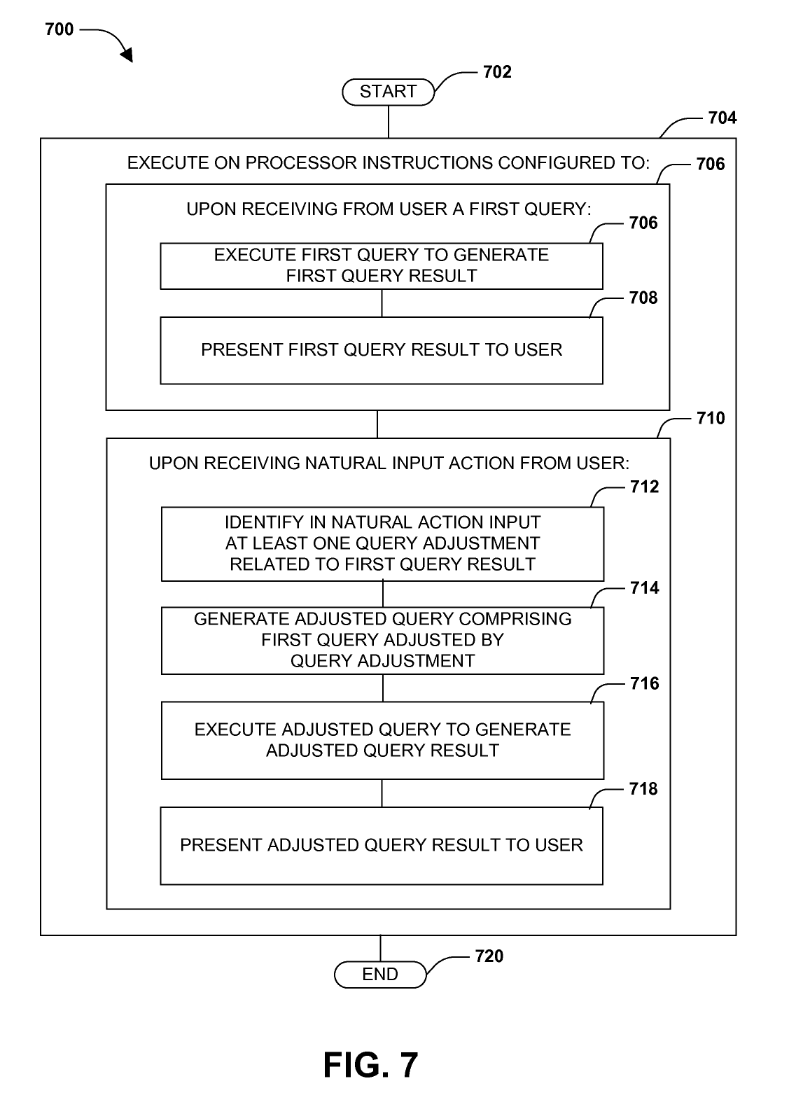

FIG. 7 presents an illustration of a third embodiment of these techniques, comprising an exemplary method 700 of configuring a device 104 to evaluate queries 108 presented by a user 102. The exemplary method 700 may be implemented, e.g., as a set of instructions stored in a memory component of the server (e.g., a volatile memory circuit, a platter of a hard disk drive, a solid-state storage device, or a magnetic or optical disc) that, when executed on the processor of the server, cause the server to utilize the techniques presented herein. The exemplary method 700 begins at 702 and involves executing 704 the instructions on the processor of the server. In particular, the instructions are configured to, upon receiving 706 from the user 104 a first query 108, execute 706 the first query 108 to generate a first query result 118, and present 708 the first query result 118 to the user 102. The instructions are also configured to, upon receiving 710 a natural action input 204 from the user 102, identify 712 in the natural action input 204 at least one query adjustment 206 related to the first query result 118; generate 714 an adjusted query 208, comprising the first query 108 adjusted by the at least one query adjustment 206; execute 716 the adjusted query 208 to generate an adjusted query result 210; and present 718 the adjusted query result 210 to the user 102. Notably, the device may perform the identification by directly evaluating the natural action input 204; by utilizing natural action input metadata 406 provided with the query result 118, such as in the exemplary scenario 400 of FIG. 4; or by invoking an action broker 602 to identify the natural action inputs 204 applicable to the query result 118, such as in the exemplary scenario 600 of FIG. 6. In any of these variations, the exemplary method 700 achieves the processing, presentation, and adjustment of the query 108 and the query result 118 in accordance with the techniques presented herein, and so ends at 720.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

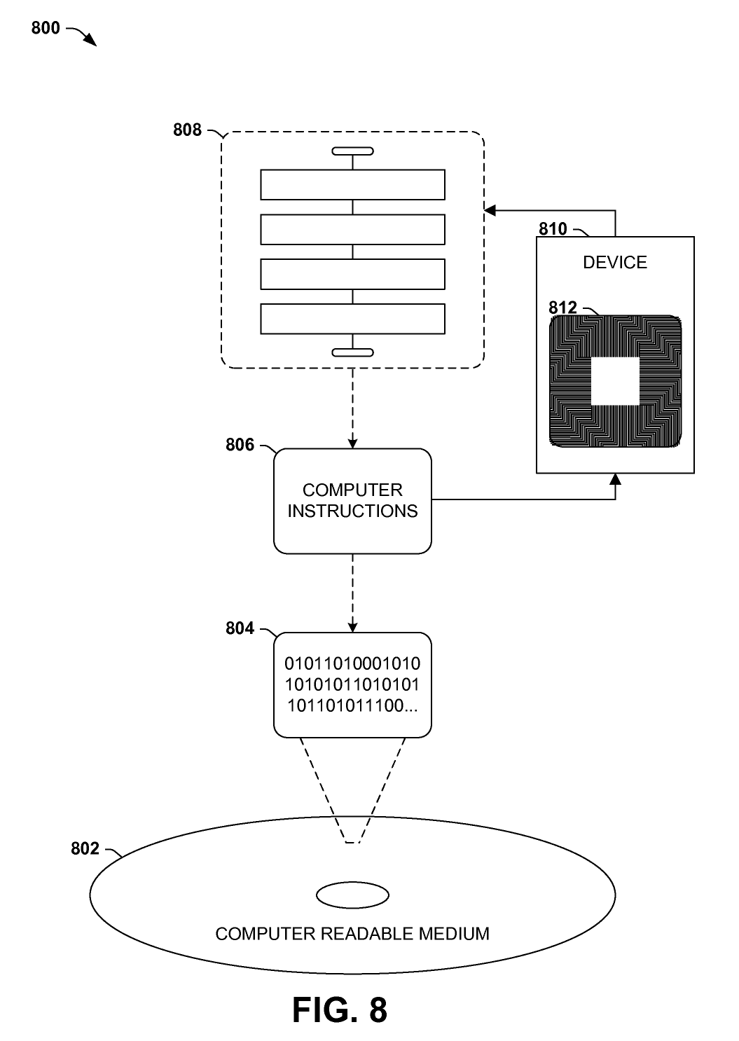

An exemplary computer-readable medium that may be devised in these ways is illustrated in FIG. 8, wherein the implementation 800 comprises a computer-readable medium 802 (e.g., a CD-R, DVD-R, or a platter of a hard disk drive), on which is encoded computer-readable data 804. This computer-readable data 804 in turn comprises a set of computer instructions 806 configured to operate according to the principles set forth herein. In one such embodiment, the processor-executable instructions 806 may be configured to perform a method of presenting a user interface within a graphical computing environment, such as the exemplary method 300 of FIG. 3, the exemplary method 500 of FIG. 5, and/or the exemplary method 700 of FIG. 7. Some embodiments of this computer-readable medium may comprise a computer-readable storage device (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variations

The techniques presented herein may be implemented with variations in many aspects, and some variations may present additional advantages and/or reduce disadvantages with respect to other variations of these and other architectures and implementations. Moreover, some variations may be implemented in combination, and some combinations may feature additional advantages and/or reduced disadvantages through synergistic cooperation.

D1. Scenarios

A first aspect that may vary among embodiments of these techniques relates to the scenarios wherein such techniques may be utilized.

As a first variation of this first aspect, these techniques may be utilized with various types of devices 104, such as workstations, servers, kiosks, notebook and tablet computers, mobile phones, televisions, media players, game consoles, and personal information managers, including a combination thereof. These devices may be used in various contexts, such as a stationary workspace, a living room, a public space, a walking context, or a mobile environment such as a vehicle. Additionally, and as illustrated in the contrasting exemplary method of FIGS. 4, 6, and 7), the architectures and distribution of such solutions may vary, such that a first device that identifies available natural action inputs 204 and the corresponding query adjustments 206, and a second device that utilizes such information by applying the query adjustments 206 upon receiving a corresponding natural action input 204 from the user 102.

As a second variation of this first aspect, these techniques may utilize many forms of natural action input 204. For example, a device may be capable of receiving various forms of natural action input 204 of a natural action input type selected from a natural action input type set, including a spoken utterance or vocal inflection received by a microphone; a written utterance, such as handwriting upon a touch-sensitive device; a touch gesture contacting a touch-sensitive display; a manual gesture not touching any component of the device 104 but detected by a still or motion camera; or an optical movement, such as optical gaze directed at a location on the display 106 of the device 104 or to an object in the physical world.

As a third variation of this first aspect, these techniques may be applied to many types of queries 108 and query results 118, such as searches of files in a file system; queries of records in a database; filtering of objects in an object set, such as email messages in an email store; and web searches of web pages in a content web. Additionally, the queries 108 may be specified in many ways (e.g., a set of keywords, a structured query in a language such as the Structured Query Language, a set of criteria with Boolean connectors, or a natural-language query), and the query result 118 may be provided in many ways (e.g., a sorted or unsorted list, a set of preview representations of entities 120 in the query result 118 such as thumbnail versions of images, or a selection of a single entity 120 matching the query 108). Those of ordinary skill in the art may identify many variations in the scenarios where the techniques presented herein may be utilized.

D2. Identifying Query Adjustments

A second aspect that may vary among embodiments of techniques relates to the manner of evaluating the natural action input 204, identifying a query adjustment 206, and applying the query adjustment 206 to the query 106 to generate an adjusted query 208 and an adjusted query result 210.

As a first variation of this second aspect, the query adjustments 206 associated with respective natural action inputs 204 may be received with the query result 118 (as in the exemplary scenario 500 of FIG. 5). For example, the first query result 118 may specify at least one query adjustment 206 associated with a natural action request, and the device 104 presenting the query result 118 may, upon receiving natural action input 204 from the user 102, identify in the natural action input 204 a natural action request specified with the first query result 108, and select the query adjustment 206 associated with the natural action request. This variation may reduce the computational burden on the device 102 by partially pre-evaluating natural action input 204 and corresponding query adjustments 206, which may be advantageous for portable devices with limited computational resources. Alternatively, a device 104 may identify the query adjustment 206 upon receiving the first query result 118 by evaluating the first query result 118 to identify at least one natural action request indicating a query adjustment 206 of the first query 108; and upon receiving natural action input 204 from the user 102, identifying in the natural action input 204 a natural action request specified by the first query result 118, and selecting the query adjustment 206 associated with the natural action request. In this variation, the device 104 first predicts the types of natural action requests that the user 102 may specify for the query result 118, and then stores and uses this information to evaluate the natural action input 204 received from the user 102. As yet another alternative, a device 104 may be configured to perform the entire evaluation of the natural action input 204 to identify corresponding query adjustments 206 upon receiving the natural action input 204.

As further examples of this first variation of this first aspect, the evaluation within the device 104 may be implemented in various ways. For example, for a device 104 executing an application within a computing environment (such as an operating system, a virtual machine, or a managing runtime), the evaluation may be performed by the application receiving the query 108 from the user 102 and presenting the query result 118 to the user 102. Alternatively, the evaluation may be performed by the computing environment, which may present the adjusted query result 210 to the application. For example, the computing environment may provide an application programming interface (API) that the application may invoke with a query result 118 and a natural action input 204 received from the user 102, and the API may respond with an adjusted query 208. Alternatively, the computing environment may monitor the delivery of query results 118 to the application and may perform the query adjustments 206 corresponding to natural action inputs 204 received from the user 102, e.g., by intercepting an original query 108 issued by a web browser to a search engine, adjusting the query 108, and presenting the adjusted query result 210 to the web browser instead of the first query result 118.

As a second variation of this second aspect, the query result 118 may be modified to facilitate the receipt of natural action input resulting in a query adjustment 206. As a first such example, the first query result 118 may comprise at least one entity, and the first query result 118 may insert a natural-language entity reference associated with the entity. As one such scenario, the query result 118 may comprise a set of search results, but it may be difficult for the user 102 to identify particular search results using natural action input such as voice. Instead, the search results may be presented with numerals that enable the user to reference them with natural action input (e.g., “show me result number three”). These natural-language entity references may be included by a server returning the query result 118, or may be inserted by the device 104.

As a second such example, the device 104 may present various input components, some of which may not be associated with the query result 118. For example, while searching for information about an event, the user 102 may reference a calendar application provided by the computing environment of the device 104. While the calendar application may not have any direct association with the query result 118, the user's accessing of the calendar and selection of a date from the calendar may be interpreted as natural action input requesting a query adjustment 206, and the device 104 may use the input component value provided by the user through this input component to formulate a query adjustment 206.

As a third variation of this second aspect, the device 104 may utilize a query adjustment 206 in various ways to generate an adjusted query result 210. As a first such example, the device 104 may send reformulate the first query 108 to generate an adjusted query 208 and send it to a server. As a second such example, the device 102 may recognize the effect of the query adjustment 206 on the query result 118, and may generate the adjusted query result 210 without having to send an adjusted query 208 back to the server. For example, the device 102 may recognize that the user 102 has requested to filter a set of entities in the first query result 118 to a specific entity, and may remove the other entities from the first query result 118 to generate the adjusted query result 210.

As a fourth variation of this third aspect, a query result 118 may be associated with at least one action having an action identifier, such as an action to be performed within the context of the query results 118. For example, an application presenting the query result 118 may include a set of actions associated with specific action identifiers, such as the names or keywords “click,” “save,” and “select.” However, the user 102 may not be aware of such action identifiers, but may present natural action input 204 requesting these actions through more natural phrases or gestures. The device 102 may therefore identify alternative forms of natural action input 204 corresponding to such actions. For example, the device 102 may correlate the natural language phrase “show me that one” with a request to perform a “click” action on a particular entity in the query result 118. Alternatively, the actions may be associated with specific entities 120, and the natural action input 204 may display the actions available for respective entities 120, such as a pop-up menu of actions that may be performed when the user 102 provides natural action input 204 referencing a particular entity 120 (e.g., pointing at a specific entity 120); and when the user 102 subsequently presents a natural action request to perform one of the actions, the device 102 may comply by performing the action on the referenced entity 120.

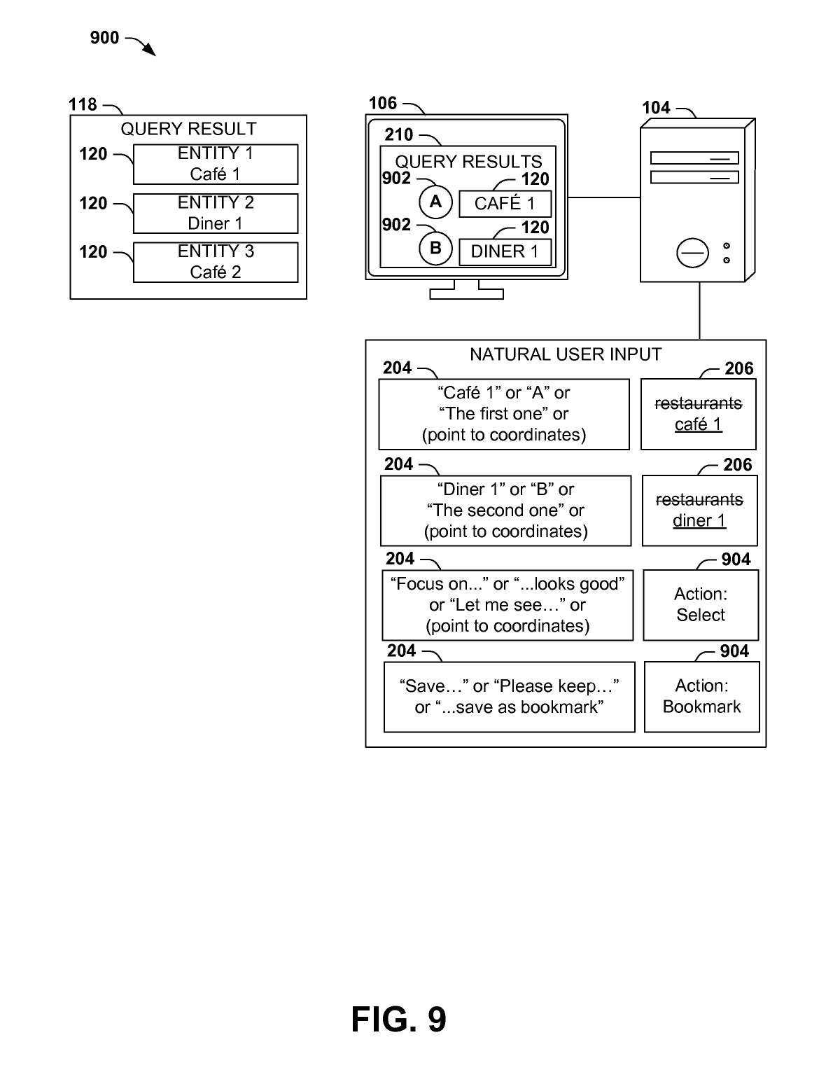

FIG. 9 presents an illustration of a first exemplary scenario 900 featuring several of the variations presented herein. In this first exemplary scenario 900, the query result 118 comprises a set of entities 404, and when presented on a display 106 of the device 104, the entities 404 may be labeled with natural-language entity references 902, such as capital letters “A” and “B”, such that the user may simply ask to see result A to adjust the query results 118. As a second example, the device 104 may associate some forms of natural action input 204 with query adjustments. Other forms of natural action input 204 may be associated other forms of natural action input 204 with actions to be performed on referenced entities (e.g., the phrase “let me see” followed by a natural-language entity reference 902 may correlate to selecting the specified entity 404 in the query result 118). Upon receiving the natural action input 204, the device may translate the natural action input 204 into the action identifier of a requested action, and may perform the specified action to fulfill the natural action input 204.

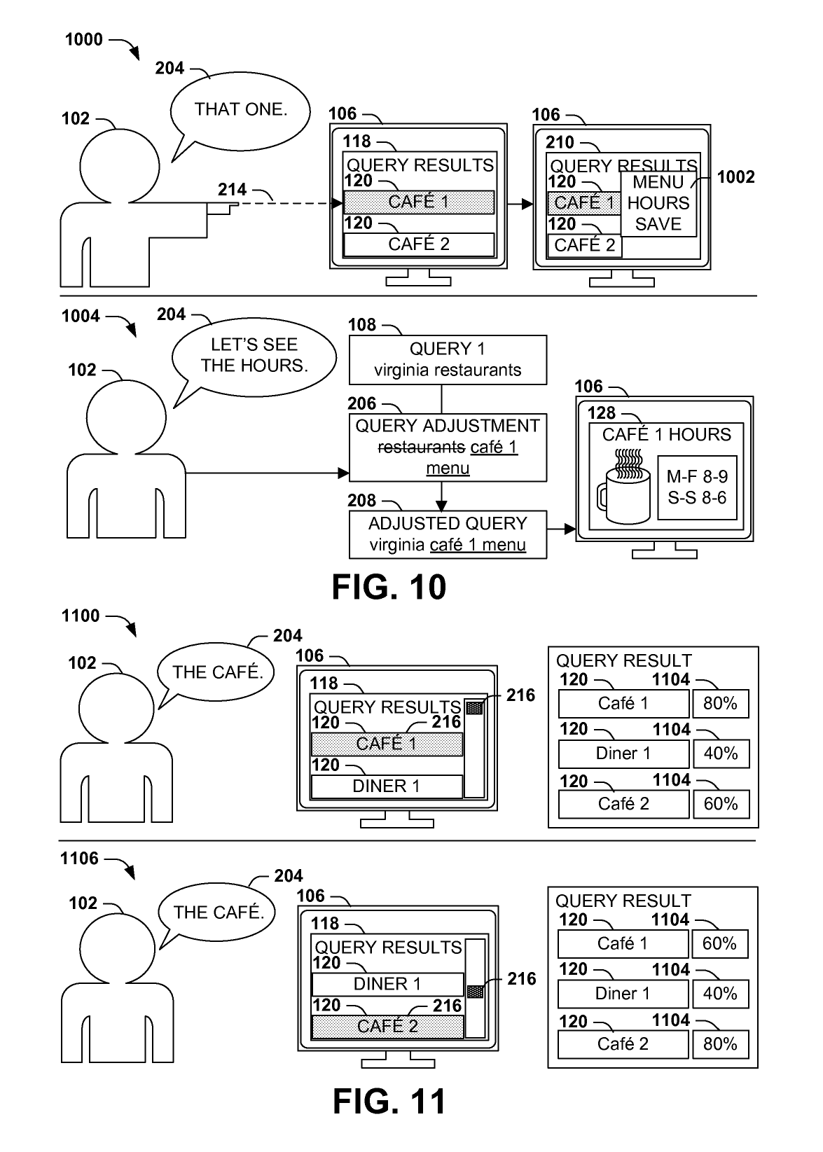

FIG. 10 presents a second exemplary scenario featuring other variations of the techniques presented herein. In this second exemplary scenario, at a first time point 1000, the user 102 first references an entity 120 of the query results 106 with natural action input by manually pointing 214 at an entity 120 and speaking the phrase, “That one.” The device 104 fulfills this natural action input 204 by selecting the entity 120, and, additionally presents a pop-up menu 1002 of actions associated with the entity 1002. At a second time point 1004, when the user 102 provides further natural action input 204 including a natural action request that is associated with one of these actions, the device 104 performs the query adjustment 206 indicated by the natural action request (e.g., speaking a phrase associated with one of the options in the pop-up menu 1002 causes the device 104 to apply the “hours” option associated with the entity 120).

As a fifth variation of this second aspect, the device 104 may utilize various queries 108 and the query adjustment 206 to facilitate the recognition of other queries 108 and query adjustment 206. As a first such example, a first query 108 may be connected with a second query 108 to identify a continued intent of the user 102 in a series of queries 108. As a second such example, the device 104 may use the first query 108 to clarify the query adjustment 206, and vice versa. For example, the natural action input 204 may comprise a reference that may be construed as ambiguous when considered in isolation, such as “let me see the show.” However, interpreting the natural action input 204 in view of the first query 108 may facilitate the recognition of the natural action input 204. For example, a speech recognizer or lexical parser for the natural action input 204 may examine the query result 118 from the first query 108 to identify the language domain for the recognition of the natural action input 204, and may therefore promote the accuracy of the language recognition. The device 104 may also utilize other information to perform this disambiguation. For example, if the natural action input 204 ambiguously references two or more entities 120 (e.g., “that restaurant”), the device 104 may utilize information to clarify the reference such as the recency with which each entity 120 has been presented to and/or referenced by the user 102, such as selectively choosing an entity 120 that is currently visible on the display 106 of the device 104 over one that is not. This disambiguation may be performed, e.g., for an ambiguous reference to a first entity (with a first probability) that is currently presented the first query result and a second entity (with a second probability) that is not currently presented in the first query result, the device 104 may raise the first probability of the first entity as compared with the second probability of the second entity.

FIG. 11 presents an illustration of an exemplary scenario featuring various probability adjustments that may be used to disambiguate natural action input 204 received from the user 102. In this exemplary scenario, the user 102 references “the café” in the context of a query result 1102 including different entities representing two different cafés. However, the display 106 may be too small to show all of the query results 1102, and may therefore present the query result in a scrollable dialog that presents only a subset of entities 120 at a time. At a first time point 1100, the user 102 specifies “the café” while the scroll position of the dialog presents the first café but not the second café, and the device 102 may accordingly configure the recognizer raise the probability 1104 that the user 102 is referencing the first café 1104 over the second café 1104. Conversely, at a second time point 1106, the user 102 specifies “the café” while the scroll position of the dialog presents the second café but not the first café, and the device 102 may accordingly configure the recognizer raise the probability 1104 that the user 102 is referencing the second café 1104 over the first café 1104. These and other variations may be compatible with the techniques presented herein.

D3. Query Adjustments

A third aspect that may vary among embodiments of these techniques relates to the effects of query adjustments 210 that may be performed on the first query 108 and the first query result 118.

As a first example of this third aspect, the query adjustment 210 may comprise a filtering of a query result 118, such as a selection of one or more entities 120 upon which the user 102 wishes the device 104 to focus. Such natural action input 204 may comprise, e.g., pointing at an entity 120, circling or framing a subset of entities 120 in the query result 118, or inputting a natural-language entity reference for one or more entities 120. The device 104 may interpret such natural action input 204 as at least one filter criterion for filtering the first query 108, and may filter the first query result 118 according to the filter criteria.

As a second example of this third aspect, the natural action input 204 may reference a prior query 108 that preceded the first query 108 (e.g., “show me these restaurants and the ones from before”). The device 104 may interpret this query adjustment 210 by combining the first query 108 and the prior query 108.

As a third example of this third aspect, the natural action input may specify a focusing on an entity 120 for further queries 120 (e.g., “show me that one”). The device 104 may fulfill this natural action input 204 by focusing the first query 108 on the referenced entity (e.g., addressing further input to the referenced entity). As one such example, the natural action input may specify an entity action to be performed on an entity 120 of the query result 118 (e.g., a request to view or bookmark a search result in a search result set). The device 104 may apply the query adjustment 210 by performing the requested entity action on the referenced entity 120.

### E. Computing Environment

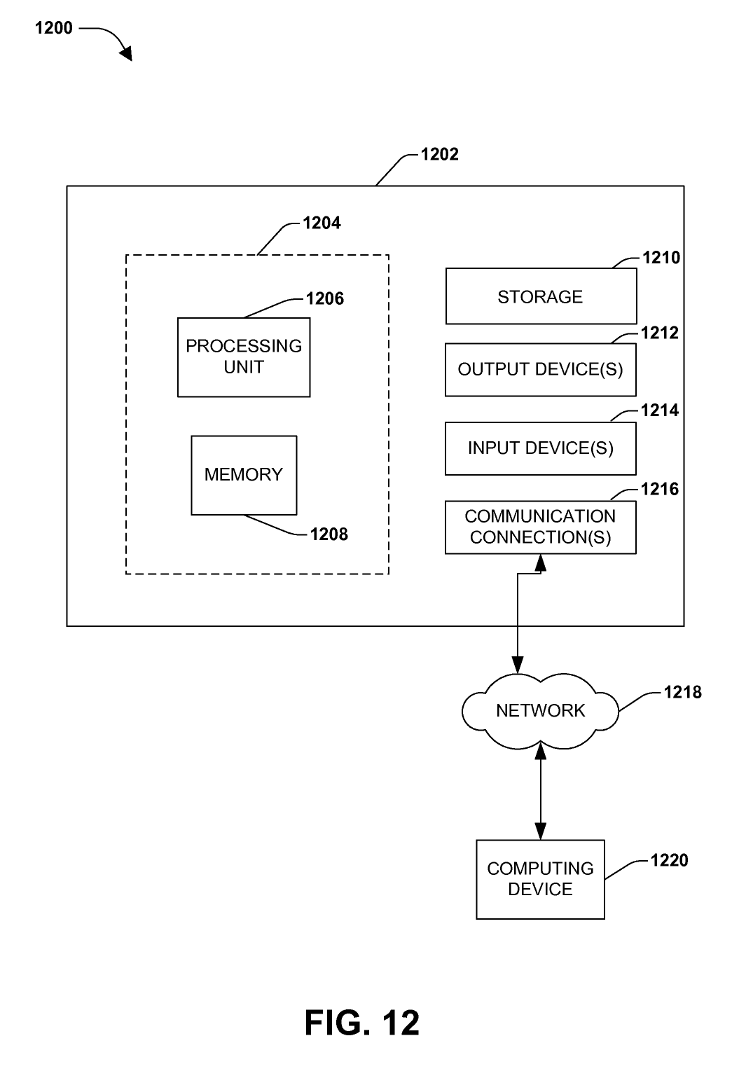

FIG. 12 presents an illustration of an exemplary computing environment within a computing device wherein the techniques presented herein may be implemented. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, and distributed computing environments that include any of the above systems or devices.

FIG. 12 illustrates an example of a system 1200 comprising a computing device 1202 configured to implement one or more embodiments provided herein. In one configuration, the computing device 1202 includes at least one processor 1206 and at least one memory component 1208. Depending on the exact configuration and type of computing device, the memory component 1208 may be volatile (such as RAM, for example), non-volatile (such as ROM, flash memory, etc., for example) or an intermediate or hybrid type of memory component. This configuration is illustrated in FIG. 12 by dashed line 1204.

In some embodiments, device 1202 may include additional features and/or functionality. For example, device 1202 may include one or more additional storage components 1210, including, but not limited to, a hard disk drive, a solid-state storage device, and/or other removable or non-removable magnetic or optical media. In one embodiment, computer-readable and processor-executable instructions implementing one or more embodiments provided herein are stored in the storage component 1210. The storage component 1210 may also store other data objects, such as components of an operating system, executable binaries comprising one or more applications, programming libraries (e.g., application programming interfaces (APIs), media objects, and documentation. The computer-readable instructions may be loaded in the memory component 1208 for execution by the processor 1206.

The computing device 1202 may also include one or more communication components 1216 that allows the computing device 1202 to communicate with other devices. The one or more communication components 1216 may comprise (e.g.) a modem, a Network Interface Card (NIC), a radiofrequency transmitter/receiver, an infrared port, and a universal serial bus (USB) USB connection. Such communication components 1216 may comprise a wired connection (connecting to a network through a physical cord, cable, or wire) or a wireless connection (communicating wirelessly with a networking device, such as through visible light, infrared, or one or more radiofrequencies.

The computing device 1202 may include one or more input components 1214, such as keyboard, mouse, pen, voice input device, touch input device, infrared cameras, or video input devices, and/or one or more output components 1212, such as one or more displays, speakers, and printers. The input components 1214 and/or output components 1212 may be connected to the computing device 1202 via a wired connection, a wireless connection, or any combination thereof. In one embodiment, an input component 1214 or an output component 1212 from another computing device may be used as input components 1214 and/or output components 1212 for the computing device 1202.

The components of the computing device 1202 may be connected by various interconnects, such as a bus. Such interconnects may include a Peripheral Component Interconnect (PCI), such as PCI Express, a Universal Serial Bus (USB), firewire (IEEE 794), an optical bus structure, and the like. In another embodiment, components of the computing device 1202 may be interconnected by a network. For example, the memory component 1208 may be comprised of multiple physical memory units located in different physical locations interconnected by a network.

Those skilled in the art will realize that storage devices utilized to store computer readable instructions may be distributed across a network. For example, a computing device 1220 accessible via a network 1218 may store computer readable instructions to implement one or more embodiments provided herein. The computing device 1202 may access the computing device 1220 and download a part or all of the computer readable instructions for execution. Alternatively, the computing device 1202 may download pieces of the computer readable instructions, as needed, or some instructions may be executed at the computing device 1202 and some at computing device 1220.

### F. Usage of Terms

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting query results to a device using a server having a processor, the method comprising:
executing on the processor instructions configured to, upon receiving a first query from the device provided by a user:
execute the first query to generate a query result;
identify at least one natural action request that, when included in a natural action input of the user, indicates a query adjustment of the first query; and
present to the device the query result and the natural action requests associated with the natural action inputs and the query adjustments.

2. The method of claim 1, the instructions further configured to, after presenting the query result to the device, upon receiving a natural action input from the device:
identifying in the natural action input at least one natural action request;
generating an adjusted query comprising the first query adjusted by the at least one query adjustment associated with the natural action request;
executing the adjusted query to generate an adjusted query result; and
present the adjusted query result to the device.

3. The method of claim 1:
the query result comprising at least one entity;
presenting the query result to the device comprising: identifying, for respective entities of the query result, at least one natural-language entity request referencing the entity.

4. A method of facilitating, using a server having a processor, query results presented by devices and comprising at least one entity, the method comprising:
executing on the processor instructions configured to, upon receiving a first query and a query result from the device:
for respective entities of the query result, identify at least one entity action associated with at least one natural action input performable by the user and a query adjustment of the first query; and
present to the device the entity actions associated with the entities, the natural action inputs, and the query adjustments.

5. A method of evaluating queries of a user on a device having a processor, the method comprising:
executing on the processor instructions configured to:
upon receiving from the user a first query:
execute the first query to generate a first query result, and
present the first query result to the user; and
upon receiving a natural action input from the user:
identify in the natural action input at least one query adjustment related to the first query result;
generate an adjusted query comprising the first query adjusted by the at least one query adjustment;
execute the adjusted query to generate an adjusted query result; and
present the adjusted query result to the user.

6. The method of claim 5, the natural action input having a natural action input type selected from a natural action input type set comprising:
a spoken utterance;
a written utterance;
a vocal inflection;
a manual gesture;
a touch action;
an optical movement.

7. The method of claim 5:
the first query result specifying at least one query adjustment associated with a natural action request; and
identifying the query adjustment comprising:
identifying in the natural action input a natural action request specified by the first query result; and
selecting the query adjustment associated with the natural action request.

8. The method of claim 5, identifying the query adjustment comprising:
upon receiving the first query result, evaluating the first query result to identify at least one natural action request indicating a query adjustment upon the first query; and
upon receiving the natural action input:
identifying in the natural action input a natural action request specified by the first query result; and
selecting the query adjustment associated with the natural action request.

9. The method of claim 8:
the instructions comprising a computing environment executing an application receiving the first query from the user and presenting the first query result; and
presenting the adjusted query result comprising: presenting the adjusted query result to the application.

10. The method of claim 5, identifying the query adjustment comprising: interpreting the natural action input within a context of the query result to identify the query adjustment.

11. The method of claim 5, identifying the query adjustment comprising:
sending the first query and the natural action input to a server; and
receiving the query adjustment from the server.

12. The method of claim 5:
the query result associated with at least one action having an action identifier; and
the query adjustment comprising:
identifying at least one natural action request specifying the action other than the action identifier; and
adjusting the first query according to the action.

13. The method of claim 5:
at least one action associated with an entity of the query result; and
presenting the query result comprising: presenting with an entity of the query result at least one action identifier associating an action with the entity.

14. The method of claim 5:
the natural action input comprising at least one filter criterion for filtering the first query; and
the query adjustment comprising: filtering the first query according to the at least one filter criterion.

15. The method of claim 5:
the natural action input comprising a reference to a prior query; and
the query adjustment comprising: combining the first query and the prior query.

16. The method of claim 5:
the natural action input directed to an input component separate from the query result and resulting in an input component value; and
the query adjustment comprising: associating the input component value with the query result.

17. The method of claim 5:
the natural action input specifying an entity action to be performed on an entity of the first query result; and
the query adjustment comprising: specifying the entity action to be performed on the entity.

18. The method of claim 5:
the natural action input referencing an entity of the first query result; and
the query adjustment comprising:
identifying the entity of the first query result referenced by the natural action input; and
focusing the first query on the entity referenced by the natural action input.

19. The method of claim 18:
the first query result comprising at least one entity;
presenting the first query result comprising: presenting with respective entities of the first query result at least one natural-language entity reference associated with the entity; and
identifying the entity referenced by the natural action input comprising: identifying an entity associated with a natural-language entity reference in the natural action input.

20. The method of claim 18:
the first query ambiguously referencing:
with a first probability, a first entity that is currently presented the first query result, and
with a second probability, a second entity that is not currently presented in the first query result; and
the query adjustment comprising: raising the first probability of the first entity as compared with the second probability of the second entity.
